(19) United States
(12) Patent Application Publication
(10) Pub. No.: US 2004/0111874 A1
(43) Pub. Date: Jun. 17, 2004

(54) Preparation of a lithium ion conductor

(76) Inventors: Kerstin Schierle-Arndt, Zwingenberg (DE); Gunther Huber, Ludwigshafen (DE); Werner Weppner, Heikendorf (DE); Christian Dietz, Kiel (DE)

Correspondence Address: Herbert B. Keil, KEIL & WEINKAUF, 1350 Connecticut Ave., N.W., Washington, DC, 20036, US

(21) Appl. No.: 10/731,161

(22) Filed: Dec. 10, 2003

(30) Foreign Application Priority Data
Dec. 16, 2002 (DE) 10259022.2

(51) Int. Cl. H01G 2/00; H01M 6/00

(52) U.S. Cl. 29/623.1; 252/62.2

(57) ABSTRACT

A lithium ion conductor having the composition Li₄₋ₓSi₁₋ₓPₓO₄, where x is at least 0.3 and not more than 0.7, is prepared by shaping and calcining Li₄₋ₓSi₁₋ₓPₓO₄, where x is at least 0.3 and not more than 0.7, and/or compounds which are converted into this during calcination, wherein the Li₄₋ₓSi₁₋ₓPₓO₄ and/or the compounds is/are used in the form of powder having a mean particle size of not more than 5 microns.

The present invention relates to a process for preparing a lithium ion conductor. In particular, the invention relates to a process for preparing a solid lithium ion conductor which is suitable for the isolation of lithium from lithium amalgam by electrolysis over a solid electrolyte which conducts lithium ions. It also relates to a process for isolating lithium.

Lithium is an important basic inorganic chemical and is required in a variety of industrial applications. For example, lithium is used for producing organolithium compounds which in turn serve as strong bases or starting materials for specific syntheses, as alloying additives or in lithium batteries. Ullmann's Encyclopedia of Industrial Chemistry, 6th edition, 2000 Electronic Release, keyword “Lithium and Lithium Compounds”, in particular sections 5.1 “Production of Lithium Metal” and 5.2 “Uses of Lithium Metal”, gives an overview of the prior art relating to the production and use of lithium. The usual industrial method of producing lithium is melt electrolysis of a eutectic mixture of lithium chloride with potassium chloride at from 400 to 460° C. This process requires a comparatively large quantity of energy (28-32 kWh/kg of lithium) and, in addition, only anhydrous lithium chloride can be used. Since lithium chloride is hygroscopic, the necessity of drying has an additional adverse effect on the economics of this process.

DE 199 14 221 A1 (US equivalent: U.S. Pat. No. 6,287,448) discloses a comparatively economical process for preparing lithium from aqueous solutions, in which a lithium amalgam is firstly produced from an aqueous lithium salt solution and, in a second step, lithium is isolated from this amalgam by connecting the amalgam as anode in an electrolysis cell having a solid electrolyte which conducts lithium ions and a lithium cathode. The solid electrolyte, viz. a ceramic material or a glass, separates the anode and cathode spaces in a “helium-type” manner but is permeable to lithium ions. A number of types of suitable solid electrolytes which conduct lithium ions are mentioned, namely a) Li-β″-Al₂O₃ or Li-β-Al₂O₃, b) lithium analogues of NASICON ceramics having a particular structure and composition, c) LISICONS having a particular structure and composition, d) lithium ion conductors having a perovskite structure and a particular composition and e) sulfidic glasses.

Another class of known lithium ion conductors is derived from lithium silicate in which silicon is partly replaced by aluminum, phosphorus and/or sulfur. For example, U.S. Pat. No. 4,042,482 discloses monoclinic compounds of the formula Li_{4+w-x-y}Si_{-w-x-y}Al_{w}PₓS_{y}O₄, where w is from 0 to 0.45, x is from 0 to 0.5 and y is from 0 to 0.35 and at least one of the two values w and (x+2y) is 0.1 or more. R. A. Huggins, Electrochimica Acta 22 (1977) 773-781 teaches the preparation of solid solutions of LiSiO₄ and Li₃PO₄ by hot pressing a stoichiometric mixture of lithium hydroxide, silicon dioxide and ammonium dihydrogen phosphate. In Mat. Res. Bull. 11 (1976) 1227-1230 and in J. Electrochem. Soc. 124 (1977) 1240-1242, Y.-W Hu, I. D. Raistrick and R. A. Huggins disclose processes for preparing such compounds by hot pressing a mixture of lithium phosphate and lithium silicate. R. D. Shannon, B. E. Taylor, A. D. English and T. Berzins, Electrochimica Acta 22 (1977) 783-796, teach the preparation of such compounds by mixing lithium hydroxide, silicon dioxide and aluminum hydroxide at 850° C. Although these disclosures mention the possibility of using these compounds as ion conductors in lithium batteries, they have not been employed in practice for this purpose.

DE 199 48 548 A1 discloses paste-like compositions for electrochemical components, which comprise nanocrystalline materials and a matrix, including Li_{0.5}Si_{0.5}P_{0.5}O₄ which at particle sizes below 10 microns is paste-like even without a matrix. DE 44 36 392 A1 teaches ferroelectric metal niobates and tantalates of the general composition Me(II)A₂O₆ or Me(III)AO₄, where A is Nb and/or Ta and Me(II) and Me(III) are each a divalent or trivalent metal, namely Mg, Fe, Co, Ni, Cr, Mn, Cd and/or Zn, which further comprise from 0, 1 to 20 mol % of Li, Na and/or K and have a perowskite structure. DE 34 15 326 A1 discloses a process for preparing phase-pure lithium morthosilicate Li₄SiO₄ from lithium hydroxide and amorphous SiO₂. EP 714 850 A2 teaches a process for preparing double metal oxides of the formula XMO₃, where X is Li, Na, K, Pb, Ba, Mg, Ca, Sr, La, Y or Bi and M is Al, Mn, Ti, Zr, Sn, Mg, Zn, Fe, Co, Ni, Nb, Ta or W, having particle sizes below 1 micron, by calcination of a mixture of the oxides of X and M, an amorphous double metal oxide or appropriate precursors. WO 89/12027 A1 discloses a process for preparing ceramic powders and thin layers by preparing an aqueous solution of metal salts and an amino acid, concentrating the solution to obtain a desirably high viscosity, applying it to a substrate and pyrolysing it.

Ion conductors for the preparation of lithium have to satisfy a number of requirements in order to be suitable. Apart from suitable electrochemical properties (for example good conductivity for lithium ions under the process conditions employed, stability to liquid lithium and lithium amalgam and a negligibly low electron conductivity), they should also be simple and inexpensive to produce, be stable on storage and easy to handle and have a very high stability and thus a long life. A particular problem is the formation of microcracks which form under electrochemical stress or grow larger and lead to leakages of mercury into the lithium produced. The ion conductors known for the isolation of lithium do not fulfill all these requirements in a fully satisfactory manner. For example, Li-βΔ-Al₂O₃, Li-β-Al₂O₃ or lithium analogues of NASICON ceramics, which are preferred from the point of view of their electrochemical properties, are comparatively expensive and, owing to their hygroscopic nature, special precautions have to be taken when handling and storing them to ensure that their performance in the process is not impaired.

It is an object of the present invention to find an improved process for the isolation of lithium and, in particular, further lithium ion conductors which can be used in this process and satisfy the abovementioned requirements. A further object is to find a process for preparing such ion conductors.

We have found that this object is achieved by a process for isolating lithium from lithium amalgam by electrolysis over a solid lithium ion conductor which has the composition Li₄₋ₓSi₁₋ₓPₓO₄, where x is at least 0.3 and not more than 0.7. We have also found a process for preparing a solid lithium ion conductor having the composition Li₄₋ₓSi₁₋ₓPₓO₄, where x is at least 0.3 and not more than 0.7, by shaping and calcining Li₄₋ₓSi₁₋ₓPₓO₄, where x is at least 0.3 and not more than 0.7 and/or compounds which are converted into this during calcination, wherein the Li₄₋ₓSi₁₋ₓPₓO₄ and/or the compounds is/are used in the form of powder having a mean particle size of not more than 5 microns.

The invention is firstly based on the recognition that the lithium phosphate silicates to be used according to the present invention are good lithium ion conductors for the recovery of lithium from lithium amalgam. Secondly, it is based on the recognition that the use of comparatively finely divided lithium salts makes it possible to produce particularly impermeable lithium phosphate silicates which are particularly resistant to crack formation and are therefore impermeable and very stable.

The process of the present invention for isolating lithium from lithium amalgam by electrolysis over a solid lithium ion conductor is carried out in an electrolysis cell whose anode and cathode spaces are separated by a solid electrolyte which conducts lithium ions and has the composition Li₄₋ₓSi₁₋ₓPₓO₄, where x is generally at least 0.3 and preferably at least 0.4 and is generally not more than 0.7 and preferably not more than 0.6. A preferred solid electrolyte is Li₄₋ₓSi₁₋ₓPₓO₄ in which x is about 0.5, and a particularly preferred solid electrolyte is Li₄₋ₓSi₁₋ₓPₓO₄ in which x is 0.5.

Processes for isolating lithium from lithium amalgam by electrolysis over a solid lithium ion conductor which separates the anode and cathode spaces of an electrolysis cell are known. The process of the present invention is carried out like the known processes except that the lithium ion conductor Li₄₋ₓSi₁₋ₓPₓO₄ to be used according to the present invention, in which x is in the range from 0.3 to 0.7, is used as wall (“membrane”) separating cathode and anode spaces. In particular, the process of the present invention for isolating lithium from lithium amalgam is carried out precisely like the process known from DE 199 14 221 A1 (or from its equivalents EP 1 041 177 and U.S. Pat. No. 6,287,448), except that the lithium ion conductor Li₄₋ₓSi₁₋ₓPₓO₄ to be used here according to the present invention, in which x is in the range from 0.3 to 0.7, is employed as wall (“membrane”) separating the cathode and anode spaces of the electrolysis cell. Its teachings are hereby expressly incorporated by reference.

The lithium amalgam used in the process of the present invention for the isolation of lithium is a solution of lithium in mercury which is liquid at the reaction temperature employed. It generally contains at least 0.02% by weight of lithium (about 0.5 atom %) and preferably contains at least 0.04% by weight of lithium (about 1 atom %) and generally not more than 0.19% by weight of lithium (5 atom %) and preferably not more than 0.1% by weight of lithium (about 3 atom %), balance mercury. It can be prepared in any way, for example from an aqueous lithium salt solution in an electrolysis cell by the amalgam process. For this purpose, a lithium chloride solution having a lithium chloride content of from 220 to 350 g/l is fed in and lithium amalgam is produced at the cathode and chlorine is produced at the anode, completely analogous to the known amalgam process for chloralkali electrolysis by means of which chlorine and sodium amalgam, for example, are produced worldwide on a large scale. The sodium amalgam is often decomposed by means of water to produce sodium hydroxide. It is likewise possible to use other sources of lithium, for instance lithium waste from batteries and reaction solutions like the lithium salt solutions formed in the reaction of organolithium compounds with halogen-substituted compounds and subsequent aqueous work-up. This usually gives aqueous lithium chloride solutions, but it is also possible to use other lithium halides and other lithium salts such as lithium sulphate, lithium sulphonates or lithium salts of organic acids. If lithium chloride is used, chlorine is produced anodically in the preparation of lithium amalgam and this is processed further in a customary fashion; if other lithium salts are used, other process engineering measures may have to be employed (the use of lithium sulphate results, for example, in formation of oxygen at the anode and a pH of the liquor of generally from 2 to 4 has to be set and maintained by addition of lithium-containing bases.) These measures are known.

To isolate metallic lithium from lithium amalgam, the lithium amalgam is used as liquid anode which is preferably kept in motion in an electrolysis cell. The lithium amalgam anode is separated from the cathode space in which liquor lithium is present by a dividing wall which conducts lithium ions and is otherwise very impermeable. During electrolysis in such a cell, the lithium is conveyed from the amalgam in the form of lithium ions through the membrane which conducts lithium ions into the cathode space and is there reduced to the metal. The anode potential is set so that virtually no metals which are more noble than lithium are oxidized, in particular no mercury is oxidized to mercury ions. The lithium metal obtained is taken off from the cathode space and processed further in a customary fashion. Fresh liquid amalgam is fed into the anode space and lithium-depleted amalgam or mercury is taken off from this space. The mercury or the depleted amalgam is recirculated to the lithium amalgam synthesis. The process is carried out at a temperature at which both lithium amalgam and lithium are liquid and the conductivity for lithium ions of the dividing wall which conducts lithium ions is sufficiently high. The reaction temperature is typically at least 150° C., preferably at least 180° C. and particularly preferably at least 200° C. and generally not more than 450° C., preferably not more than 400° C. and particularly preferably not more 350° C. A pressure which is slightly above that on the anode side is preferably applied on the cathode side to prevent leakages of mercury into the lithium obtained. This overpressure is generally at least 0.1 bar, preferably at least 0.5 bar, and generally not more than 5 bar and preferably not more than 1 bar.

The dividing wall which conducts lithium ions (also referred to simply as ‘membrane’, “ion conductor”, “ceramic” or “solid electrolyte”) separates the anode space and cathode space from one another. The seal is made “helium-tight” so that no substances apart from lithium in ionic form are exchanged between anode space and cathode space.

The shape chosen for the dividing wall depends on the shape of the electrolysis cell. An advantageous and frequently used shape of the dividing wall which conducts lithium ions is that of a tube which is closed at one end and has a circular or other cross section and at whose open end there is an electrically insulating seal, for instance an electrically insulating ring with a helium-tight, electrically insulating glass solder connection. Such constructions are known, for example from GB 2 207 5645 A, EP 482 785 A1. The thickness of the dividing wall is chosen so that sufficient mechanical strength (stability and pressure resistance) and impermeability are achieved but migration of the lithium ions through the dividing wall is not made unnecessarily difficult. It is in general at least 0.3 mm and preferably at least 1 mm and generally not more than 5 mm, preferably not more than 3 mm and particularly preferably not more than 2 mm.

The impermeability of the dividing wall has to meet high standards in order to avoid leakage of metallic mercury into the lithium which has been obtained. “Helium-tight” dividing walls which have leakage rates of less than 10⁻⁹ mbar per liter and second in a helium leakage test are desirable. The other seals in the system should also be liquid-tight and gastight in order to prevent diffusion of mercury vapor into the environment or into the lithium obtained.

To produce dividing walls which conduct lithium ions and are to be used according to the present invention, Li₄₋ₓSi₁₋ₓPₓO₄, where x is at least 0.3 and not more than 0.7, is brought to the desired shape of the dividing wall. This can be carried out in any conceivable way, for example by shaping an Li₄₋ₓSi₁₋ₓPₓO₄ powder or by synthesis of the compound in the desired shape. A simple and preferred method is shaping a compound or a mixture of compounds which finally react to give Li₄₋ₓSi₁₋ₓPₓO₄ in powder form and in the desired stoichiometry and subsequently reacting the powder or powder mixture in the shaped part to form Li₄₋ₓSi₁₋ₓPₓO₄, where x is at least 0.3 and not more than 0.7.

In principle, it is possible to use all compounds and mixtures of compounds which during the preparation of the ion conductor react to give Li₄₋ₓSi₁₋ₓPₓO₄ as final product. It is convenient and preferred to use lithium phosphate and lithium silicate as anhydrous ortho compounds Li₃PO₄ and Li₄SiO₄. However, it is likewise possible to use compounds which are converted into these substances during the course of the preparation of the ion conductor. It is likewise possible to use compounds containing water of crystallization or hydrates such as Li₃O₄.½H₂O, meta compounds such as Li₂SiO₃ or LiPO₃ or hydrogen salts such as Li₂HPO₄ or LiH₂PO₄. The stoichiometry can also be adjusted by addition of phosphorus oxides such as P₂O₅ or P₂O₃, silicon dioxide, including silicon hydroxide in hydrated or partly hydrated form (“silica gel”), lithium oxide and/or lithium hydroxide.

Preference is given to using pulverulent starting materials which have a particular mean particle size. The mean particle size (often also referred to as “d50”) is such that 50% by weight of the powder is present in the form of particles having a particle size of not more than this mean particle size. In the case of relatively coarse particles, the mean particle size is measured by means of sieves, while in the case of finer particles in the size range of only a few microns, use is generally made of laser light scattering (in accordance with the ISO/DIS standard 13320 “Particle Size Analysis Guide to Laser Diffraction). In the case of spherical particles, the particle size measured corresponds to the sphere diameter, while in the case of nonspherical particles, the measurement method necessarily gives an effective diameter of the particles which corresponds to the diameter of spherical particles having the same volume. Analogously, the powders have d90 values, at which 90% by weight of the powder is present in the form of particles having an effective diameter of not more than this value.

The mean particle size of the pulverulent starting materials used is generally not more than 5 microns. It is preferably not more than 3 microns and particularly preferably not more than 1 micron.

It is not absolutely necessary but is preferred for the powder used to contain few or no comparatively coarse particles. In other words, the d90 is preferably not very much higher than the d50. The d90 is preferably not more than five times the d50 and particularly preferably not more than three times the d50.

If the powder used does not have this particle size, it is brought to this particle size prior to shaping. This can be carried out using any known comminution process. Particularly useful apparatuses for this purpose are ball mills or attritor mills into which the powder is usually introduced as a suspension in an inert suspension medium (for example water, alcohols, ethers or hydrocarbons). Preference is given to using alcohols, in particular C₁-C₄-alcohols (methanol, ethanol, propanol, isopropanol, butanol, sec-butanol, isobutanol, tert-butanol) as suspension medium. Attritor mills can achieve d50 values of about 0.5 microns. The most important parameter when using ball or attritor mills is the milling time. Milling is always continued until the desired fineness has been reached. If a mixture of compounds is used, joint milling can conveniently at the same time effect the intensive mixing necessary before shaping.

Shaping of the ion conductor or a mixture of substances from which it is prepared to produce the desired shape is carried out using known shaping methods, for example cold isostatic pressing, hot isostatic pressing, slip casting or tape casting. For this purpose, the powder is, if necessary after milling and if necessary after removal of suspension medium, subjected to the appropriate process. A preferred shaping process is cold isostatic pressing. For this purpose, the powder is pressed in a mold under a pressure of generally at least 1000 bar, preferably at least 2000 bar and particularly preferably at least 3000 bar.

Subsequent to shaping or at the same time as shaping (for instance in the case of hot isostatic pressing), the ion conductor is fired to full density by heating (“heat treatment”, “calcination” or “sintering”) so as to produce the finished dividing wall of the electrolysis cell. If shaping has not been carried out using Li₄₋ₓSi₁₋ₓPₓO₄ in which x is at least 0.3 and not more than 0.7 itself, this ion conductor is also produced from the powder mixture used during sintering. Sintering is carried out by heating the shaped bodies to a temperature of generally at least 700° C., preferably at least 800° C. and particularly preferably at least 900° C. Sintering is continued until an ion conductor of the desired density is obtained at the temperature set. In general, the sintering temperature is held for at least 15 minutes, preferably at least 30 minutes and particularly preferably at least 1 hour. Sintering is generally complete after no more than 10 hours; sintering is preferably carried out for not more than 6 hours and particularly preferably for not more than 4 hours. On heating and cooling the shaped bodies to or from the sintering temperature, care has to be taken to ensure that temperature stresses do not cause cracks. The heating or cooling rate is therefore generally not more than 20° C./min, preferably not more than 1° C./min and particularly preferably not more than 5° C./min.

Lithium ion conductors which have a high density and cracking resistance and are very suitable for lithium production can be produced in this way.

### EXAMPLES

### Example 1

### Preparation of a Lithium Ion Conductor Having the Composition Li₄₋ₓSi₁₋ₓPₓO₄, x=0.5

15.0 g (0.125 mol) of LiSiO₄ and 14.49 g (0.125 mol) of Li₃PO₄ were placed in a zirconium dioxide container and slurried in 20 ml of isopropanol. Three spherical milling media having diameters of 0.5 and 2 cm were in each case placed in the container. The closed container was left on a ball mill for 12 hours. The isopropanol was subsequently removed by evaporation and the powder which remained was pressed through a sieve. The powder was shaped into a crucible shape by cold isostatic pressing at a pressure of 3500 bar, heated at a heating rate of 1° C./min to 1000° C., sintered at this temperature for 2 hours and subsequently cooled at a cooling rate of 1° C./min.

### Example 2

### Preparation of a Lithium Ion Conductor Having the Composition Li₄₋ₓSi₁₋ₓPₓO₄, x=0.5

15.0 g (0.125 mol) of LiSiO₄ and 14.49 g (0.125 mol) of Li₃PO₄ were placed in a zirconium dioxide container and slurried in 20 ml of isopropanol. Three spherical milling media having diameters of 0.5 and 2 cm were in each case placed in the container. The closed container was left on a ball mill for 1 hour, and the slurry was subsequently milled in an attritor mill (1.5 kg of spherical ZrO₂ milling media having a diameter of 2 mm) for another 30 minutes. The isopropanol was removed by evaporation and the powder which remained was pressed through a sieve. The powder was shaped into a crucible shape by cold isostatic pressing at a pressure of 3500 bar, heated at a heating rate of 1° C./min to 1000° C., sintered at this temperature for 2 hours and subsequently cooled at a cooling rate of 1° C./min.

### Example 3

### Lithium Ion Conduction in a Model System

The ceramic produced in example 1 was subjected to a transport measurement in the model system lithium-lithium at 195° C. This corresponds to the procedure in the electrolysis of lithium amalgam, but liquid lithium is used on both sides of the dividing wall. The polarity of the electrodes was set so that transport occurred from the exterior into the interior of the lithium ion conductor crucible. A current of 1 mA was applied for a period of 70 hours. The current yield achieved was quantitative within the measurement accuracy. Cracks in the ion conductor were not observed.

We claim:

1. A process for preparing a solid lithium ion conductor having the composition Li₄₋ₓSi₁₋ₓPₓO₄, where x is at least 0.3 and not more than 0.7, by shaping and calcining Li₄₋ₓSi₁₋ₓPₓO₄, where x is at least 0.3 and not more than 0.7, and/or compounds which are converted into this during calcination, wherein the Li₄₋ₓSi₁₋ₓPₓO₄ and/or the compounds is/are used in the form of powder having a mean particle size of not more than 5 microns.

2. A process as claimed in claim 1, wherein the Li₄₋ₓSi₁₋ₓPₓO₄ and/or the compounds which are converted into this during calcination is/are used in the form of powder having a mean particle size of not more than 3 microns.

3. A process as claimed in claim 1 or 2, wherein lithium phosphate Li₃PO₄ and lithium silicate Li₄SiO₄ are used as compounds which are converted into Li₄₋ₓSi₁₋ₓPₓO₄ during calcination

4. A process as claimed in claim 3, wherein shaping is carried out by means of cold isostatic pressing.

5. A process as claimed in claim 4, wherein a pressure of at least 1000 bar is employed during cold isostatic pressing.

6. A process as claimed in claim 3, wherein a temperature of at least 700° C. is employed during calcination.
